(19) United States
(12) Patent Application Publication
(10) Pub. No.: US 2011/0268376 A1
(43) Pub. Date: Nov. 3, 2011

(54) SLIDING APPARATUS FOR ELECTRONIC DEVICE

(75) Inventor: Wen-Bin SHEN, Tu-Cheng (TW)

(73) Assignee: HON HAI PRECISION INDUSTRY CO., LTD., Tu-Cheng (TW)

(21) Appl. No.: 12/837,467

(22) Filed: Jul. 15, 2010

(30) Foreign Application Priority Data
Apr. 30, 2010 (TW) 99207915

(51) Int. Cl. F16C 29/00; F16F 1/06

(52) U.S. Cl. 384/10; 267/166

(57) ABSTRACT

A sliding apparatus includes a first sliding member and a second sliding member slidably relative to the first sliding member. A resilient member is connected between the first and second sliding members. The resilient member appears as though it is two coil springs overlapped with each other to provide a better sense of damping for operators.

### CROSS-REFERENCE TO RELATED APPLICATION

Relevant subject matter is disclosed in co-pending U.S. patent applications (Attorney Docket Nos. US30361 and US30364), both filed on the same date, entitled “SLIDING APPARATUS FOR ELECTRONIC DEVICE,” and assigned to the same assignee as named herein.

### BACKGROUND 1. Technical Field

The present disclosure relates to sliding apparatuses and, particularly to an apparatus used for an electronic device having a slidable display.

2. Description of Related Art

Usually, displays of electronic devices are slidable for convenient operation and to save space. For example, a mobile phone generally has a main body and a slidable display mounted to the main body by a sliding apparatus. The display slides to a predetermined position, by the sliding structure. A resilient member is always used in the sliding apparatus for adding sense of damping for operators. However, the elasticity of a traditional resilient member may be insufficient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of a sliding apparatus including a resilient member.

FIG. 2 is an enlarged, isometric view of the resilient member of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

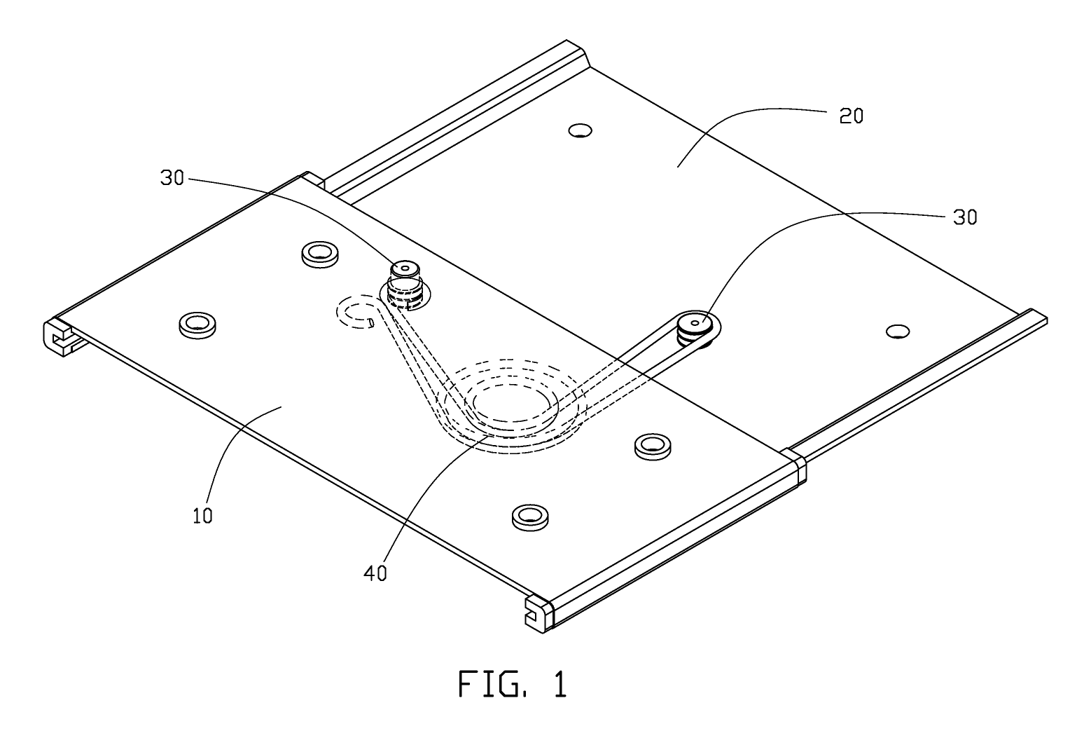

Referring to FIG. 1, an exemplary embodiment of a sliding apparatus includes a first sliding member 10, a second sliding member 20, two fasteners 30, and a resilient member 40.

The second sliding member 20 is slidably attached to the first sliding member 10. The fasteners 30 are fixed to the first sliding member 10 and the second sliding member 20, respectively.

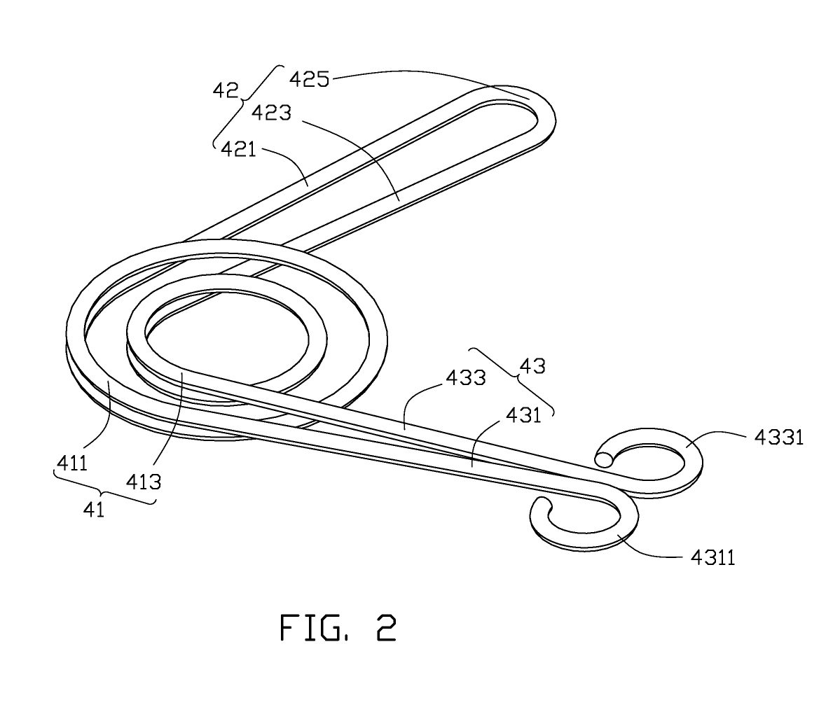

Referring to FIG. 2, the resilient member 40 appears as though it is two coil springs overlapped with each other, and includes a coil portion 41 at a middle portion, a first foot 42 and a second foot 43 extending from opposite ends of the coil portion 41 respectively. The first foot 42 includes an outside pole 421, an inside pole 423 substantially parallel to the outside pole 421, and a U-shaped clip 425 whose opposite ends coupled to the outside pole 421 and the inside pole 423 respectively. The second foot 43 includes an outside pole 431 and an inside pole 433 substantially symmetrical to the outside pole 431. The outside pole 431 and the inside pole 433 are generally J-shaped. The outside pole 431 forms a substantially C-shaped clip 4311 at a distal end of the outside pole 431. The inside pole 433 forms a substantially C-shaped clip 4331 at a distal end of the inside pole 433. The coil portion 41 includes a spiral outside coil 411 and a spiral inside coil 413. Two opposite ends of the outside coil 411 are coupled with the outside pole 421 of the first foot 42 and the outside pole 431 of the second foot 43, respectively. Two opposite ends of the inside coil 413 are coupled with the inside pole 423 of the first foot 42 and the inside pole 433 of the second foot 43, respectively. In this embodiment, the resilient member 40 is integrally formed with an elastic wire.

In assembly, the first foot 42 of the resilient member 40 is mounted to the second sliding member 20 with the clip 425 of the first foot 42 sleeved around the fastener 30 fixed to the second sliding member 20. The second foot 43 of the resilient member 40 is mounted to the first sliding member 10 with one of the clips 4311 or 4331 of the second foot 43 sleeved around the fastener 30 mounted to the first sliding member 10.

When the second sliding member 20 is slid relative to the first sliding member 10, an operator should provide more force against the elasticity of the resilient member 40. Thus the sliding apparatus provides a better sense of damping for operators.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sliding apparatus comprising:
a first sliding member;
a second sliding member slidably attached to the first sliding member; and
a resilient member connected between the first and second sliding members, wherein the resilient member comprises a coil portion at a middle portion, a first foot and a second foot extending from opposite ends of the coil portion respectively, the first foot comprises a first outside pole, a first inside pole, and a substantially U-shaped first clip whose opposite ends coupled to the first outside pole and the first inside pole respectively, the second foot comprises a second outside pole and a second inside pole, the coil portion comprises a spiral outside coil and a spiral inside coil, two opposite ends of the outside coil are coupled to the first outside pole of the first foot and the second outside pole of the second foot, respectively, two opposite ends of the inside coil are coupled to the first inside pole of the first foot and the second inside pole of the second foot, respectively.

2. The sliding apparatus of claim 1, wherein the second outside pole of the second foot and the second inside pole of the second foot are generally J-shaped.

3. The sliding apparatus of claim 2, wherein the second outside pole of the second foot forms a C-shaped second clip at a distal end, the second inside pole of the second foot forms a C-shaped third clip at a distal end, the second foot of the resilient member is mounted to the first sliding member with one of the second and third clips of the second foot fixed to the first sliding member.

4. The sliding apparatus of claim 1, wherein the second outside pole of the second foot and the second inside pole of the second foot are substantially symmetrical.

5. The sliding apparatus of claim 1, further comprises two fasteners fixed to the first sliding member and the second sliding member respectively, the resilient member is connected between the first and second sliding members with the first foot sleeved about the fastener, fixed to the second sliding member, and the second foot sleeved about the fastener, fixed to the first sliding member.

6. The sliding apparatus of claim 1, wherein the first inside pole of the first foot and the first outside pole of the first foot are substantially parallel to each other.

7. The sliding apparatus of claim 1, wherein the first foot of the resilient member is mounted to the second sliding member with the first clip of the first foot fixed to the second sliding member.

8. The sliding apparatus of claim 1, wherein the resilient member is integrally formed with an elastic wire.

9. A resilient member comprising:
a coil portion at a middle portion; and
a first foot and a second foot extending from opposite ends of the coil portion respectively, wherein the first foot comprises a first outside pole, a first inside pole, and a substantially U-shaped first clip whose opposite ends coupled to the first outside pole and the first inside pole respectively, the second foot comprises a second outside pole and a second inside pole, the coil portion comprises a spiral outside coil and a spiral inside coil, two opposite ends of the outside coil are coupled to the first outside pole of the first foot and the second outside pole of the second foot, respectively, two opposite ends of the inside coil are respectively coupled to the first inside pole of the first foot and the second inside pole of the second foot.

10. The resilient member of claim 9, wherein the second outside pole of the second foot and the second inside pole of the second foot are generally J-shaped.

11. The resilient member of claim 10, wherein the second outside pole of the second foot forms a C-shaped second clip at a distal end, the second inside pole of the second foot forms a C-shaped third clip at a distal end.

12. The resilient member of claim 9, wherein the second outside pole of the second foot and the second inside pole of the second foot are substantially symmetrical.

13. The resilient member of claim 9, wherein the first inside pole of the first foot and the first outside pole of the first foot are substantially parallel to each other.

14. The resilient member of claim 9, wherein the resilient member is integrally formed with an elastic wire.
